(19) United States
(12) Patent Application Publication
(10) Pub. No.: US 2022/0303620 A1
(43) Pub. Date: Sep. 22, 2022

(54) METHODS FOR TRANSMITTING AND RECEIVING VIDEO DATA, TERMINAL DEVICE AND SERVER

(71) Applicant: Samsung Electronics Co., Ltd., Suwon-si (KR)

(72) Inventors: Zhenxin YANG, Xi'an (CN); Chunmiao JIANG, Xi'an (CN); Bo HU, Xi'an (CN)

(73) Assignee: Samsung Electronics Co., Ltd., Suwon-si (KR)

(21) Appl. No.: 17/222,205

(22) Filed: Apr. 5, 2021

(30) Foreign Application Priority Data
Mar. 18, 2021 (CN) 202110292268.7

(51) Int. Cl. H04N 21/4402; H04N 21/2187; H04N 21/63; H04N 21/2365

(52) U.S. Cl. CPC H04N 21/440227; H04N 21/2187; H04N 21/631; H04N 21/23655

(57) ABSTRACT

The disclosure provides methods for transmitting and receiving video data, and a terminal device and a server. The server layers an original video into a plurality of video data streams, embeds extended information including feature information of a video data stream in a specified video data stream and transmits the plurality of video data streams to corresponding channels respectively for transmitting. A multicast prediction model in the terminal device may output a multicast access strategy based on the feature information of the video data stream and user experience information of the currently played video, and then a multicast combination currently accessed by the terminal device is adjusted based on the multicast access strategy to obtain a better multicast combination in the current network transmission environment, such that video data streams of corresponding quantities and quality are received. The above methods executed by the server and the terminal device can realize control of network congestion without increasing bandwidth consumption.

### CROSS-REFERENCE TO RELATED APPLICATION

This application claims priority from Chinese Patent Application No. 202110292268.7 filed on Mar. 18, 2021 in the Chinese Intellectual Property Office, and all the benefits accruing therefrom under 35 U.S.C. 119, the contents of which in its entirety are herein incorporated by reference.

### TECHNICAL FIELD

The disclosure relates to a technical field of video transmission, and in particular, to methods and devices for transmitting and receiving video data, and a terminal device and a server.

### BACKGROUND ART

A multicast is a network technology that allows one or more senders (multicast sources) to transmit a single data packet to multiple receivers, which is an effective means to save network bandwidth and reduce network load. A multicast source (such as a server) transmits a data packet to a specific multicast group, and only a receiver (such as a terminal device) belonging to an address of the multicast group may receive the data packet.

Existing multicast technologies include a single video stream multicast, a multiple video stream repeated multicast, and a layered video multicast. Among them, for the single video stream multicast technology, each receiver (such as the terminal device) may only obtain a video of a same quality (such as resolution), and a selection scenario for the video quality is relatively simple. For the multiple video stream repeated multicast technology, it may make sources with different qualities (such as different resolutions) of a same original video transmit on different channels, which causes the same video to repeatedly occupy limited network bandwidth and is likely to cause larger network transmission bandwidth, thereby resulting in an increase in traffic. In addition, redundant information processing may also cause a waste of computing resources. For the layered video multicast technology, a receiver (such as the terminal device) need to join and leave a multicast group regularly to adapt to changes in network status, which may result in problems that multicast routing and receiver rate adaptation may be overburdened and overall video quality reception may be unstable. Moreover, the existing layered video multicast technology fails to cover many application scenarios, and it responds slowly to network congestion (especially short-term congestion within the network).

### SUMMARY

The disclosure provides methods for transmitting and receiving video data, and a terminal device and a server, for the deficiency of the existing technology.

According to an aspect of the disclosure, a method for transmitting video data is provided. The method includes layering an original video into a plurality of video data streams; embedding extended information in at least one data packet of at least one video data stream among the plurality of video data streams, the extended information includes feature information of a preset video data stream; and transmitting the plurality of video data streams to corresponding channels respectively for transmitting.

As mentioned above, the original video is layered into the plurality of video data streams, and the video data may be transmitted to the multicast group addresses hierarchically through the corresponding channels. The data of different video data streams is independent of each other, compared with the existing multi-video stream repeated multicast solution, the total bandwidth of output transmission will not increase, and the network bandwidth utilization efficiency of the layered video multicast is greatly improved. In addition, by embedding the extended information (feature information), the receiver may be convenient for analyzing and predicting the multicast access strategy based on the extended information.

In example embodiments of the disclosure, the layering the original video into the plurality of video data streams includes: layering the original video into a base layer video data stream and one or more enhancement layer video data streams, the embedding the extended information in the at least one data packet of the at least one video data stream among the plurality of video data includes: embedding the extended information at least in at least one data packet of the base layer video data stream.

As mentioned above, the base layer video data stream may be independently decoded to provide a basic video quality, and the enhancement layer video data stream needs to be decoded together with the base layer video data stream to achieve video quality enhancement. Based on this, the extended information is embedded into the base layer video data stream, so that the receiver may also parse and obtain the feature information when it only receives the base layer video data stream.

In example embodiments of the disclosure, the embedding the extended information at least in the at least one data packet of the base layer video data stream includes: embedding the extended information in the at least one data packet of the base layer video data stream, the extended information includes feature information of the base layer video data stream and feature information of at least one enhancement layer video data stream.

As mentioned above, the embedding the feature information of the enhancement layer video data stream in the base layer video data stream may make the receiver only parse the base layer video data stream to obtain the feature information of the enhancement layer video data stream, thus making the acquisition of the feature information convenient and efficient.

In example embodiments of the disclosure, the embedding the extended information at least in the at least one data packet of the base layer video data stream includes: embedding the extended information in the at least one data packet of the base layer video data stream, the extended information includes feature information of the base layer video data stream and feature information of an enhancement layer video data stream adjacent to the base layer video data stream; and embedding the extended information in at least one data packet of each enhancement layer video data stream, the extended information for each enhancement layer video data stream includes feature information of the enhancement layer video data stream itself and feature information of a video data stream adjacent to the enhancement layer video data stream.

As mentioned above, the extended information is embedded in the base layer video data stream and each enhancement layer video data stream, which may not only separately parse the base layer video data stream to obtain the feature information, also may parse the base layer video data stream and the enhancement layer video data stream to obtain the feature information, such that a new choice is provided for the way in which the receiver obtains the feature information.

In example embodiments of the disclosure, the feature information of each video data stream includes at least one type of a transmission rate of a video data stream, a proportion of data size of the video data stream to data size of a base layer video data stream, and a proportion of the data size of the video data stream to a sum of data sizes of the remaining video data streams.

As mentioned above, the feature information of the video data stream may be used as training data for pre-training a multicast prediction model; the feature information may also be transmitted to the receiver during the implementation phase so that the receiver can predict a multicast strategy based on the multicast prediction model.

In example embodiments of the disclosure, the extended information further includes at least one of a first identifier for indicating that a data packet is embedded with the extended information, a number of video data streams corresponding to the feature information included in the extended information, a number of types of the feature information in the extended information and a embedding mode of the extended information.

As mentioned above, any of the extended information mentioned above is an extension of the original Coding Transport protocol (LCT), and the feature information may be easily obtained from the receiver through the extended information.

The above method of transmitting video data may be run on a server side, the method layers the original video into the base layer video data stream and several enhancement layers video data streams, embeds the feature information in these layered video streams and then transmits to the corresponding multicasts through different channels, so as to provide the available prediction data for the receiver and facilitate the receiver to develop the multicast access strategy based on the multicast prediction model.

According to another aspect of the disclosure, a method for receiving video data is provided, the method includes: receiving video data streams corresponding to a currently accessed multicast combination, wherein at least one data packet of at least one video data stream in the corresponding video data streams is embedded with extended information, and the extended information includes feature information of a preset video data stream; extracting the feature information from the extended information; acquiring quality of experience information of a currently played video based on the video; obtaining a multicast access strategy using a multicast prediction model, based on the extracted feature information and the quality of experience information; adjusting the currently accessed multicast combination based on the multicast access strategy.

As mentioned above, the method for receiving video data may be run in the receiver (such as the terminal device), the feature information may be obtained by receiving the video data stream, the feature information is combined with the quality of experience information of the video, and the multicast prediction model is used to obtain the multicast access strategy, which can more accurately guide the execution of joining/exiting actions, achieve the optimal processing of joining and exiting multicasts, greatly reduce meaningless trial-and-error actions for joining or exiting multicasts, thereby not only saving computing resources of the terminal device while reducing the pressure on upper-layer routing caused by joining or exiting multicasts. In this way, the receiver-driven hierarchical congestion control is realized without increasing bandwidth consumption, and the user experience is improved. On the other hand, since the accuracy and robustness of the multicast prediction model, the problem that the layered video multicast technology cannot cover more application scenarios due to the branch coverage of the existing trial-and-error action logic judgment is not accurate enough is avoided in the term of the technical realization principle.

In example embodiments of the disclosure, the corresponding video data streams include a base layer video data stream; or the corresponding video data streams include the base layer video data stream and one or more enhancement layer video data streams, wherein the extended information is embedded at least in at least one data packet of the base layer video data stream.

As mentioned above, the base layer video data stream may be independently decoded to provide a basic video quality, and the enhancement layer video data stream needs to be decoded together with the base layer video data stream to achieve video quality enhancement. Based on this, the extended information is embedded into the base layer video data stream, so that the receiver may also parse and obtain the feature information when it only receives the base layer video data stream.

In example embodiments of the disclosure, the extended information is embedded in the at least one data packet of the base layer video data stream, the extended information includes feature information of the base layer video data stream and feature information of at least one enhancement layer video data stream.

As mentioned above, the embedding the feature information of the enhancement layer video data stream in the base layer video data stream may make the receiver only parse the base layer video data stream to obtain the feature information of the enhancement layer video data stream, thus making the acquisition of the feature information convenient and efficient.

In example embodiments of the disclosure, the extended information is embedded in the at least one data packet of the base layer video data stream, the extended information includes feature information of the base layer video data stream and feature information of an enhancement layer video data stream adjacent to the base layer video data stream; and the extended information is embedded in at least one data packet of each enhancement layer video data stream among the one or more enhancement layer video streams, the extended information for each enhancement layer video data stream includes feature information of the enhancement layer video data stream itself and feature information of a video data stream adjacent to the enhancement layer video data stream.

As mentioned above, the extended information is embedded in the base layer video data stream and each enhancement layer video data stream, which may not only separately parse the base layer video data stream to obtain the feature information, also may parse the base layer video data stream and the enhancement layer video data stream to obtain the feature information, such that a new choice is provided for the way in which the receiver obtains the feature information.

In example embodiments of the disclosure, the feature information extracted from the extended information includes at least one type of a transmission rate of a video data stream, a proportion of data size of the video data stream to data size of a base layer video data stream, and a ratio of the data size of the video data stream to a sum of data sizes of the remaining video data streams.

As mentioned above, the feature information of the video data stream may be used for the receiver to predict a multicast strategy based on the multicast prediction model.

In example embodiments of the disclosure, the extended information further includes at least one of a first identifier for indicating that a data packet is embedded with the extended information, a number of video data streams corresponding to the feature information included in the extended information, a number of types of the feature information in the extended information and a embedding mode of the extended information.

As mentioned above, any of the extended information mentioned above is an extension of the original Coding Transport protocol (LCT), and the feature information may be easily obtained from the receiver through the extended information.

In example embodiments of the disclosure, the adjusting the currently accessed multicast combination includes any one operation of newly accessing at least one multicast other than the multicast combination currently accessed by the terminal device; exiting at least one multicast in the multicast combination currently accessed by the terminal device; remaining the current multicast combination accessed by the terminal device unchanged.

As mentioned above, the adjusting the currently accessed multicast combination is achieved through the above adjusting operations, based on the multicast access strategy predicted by the multicast prediction model.

In example embodiments of the disclosure, the quality of experience information includes at least one type of a jitter duration, an average codec bit rate and a frame rate deviation.

As mentioned above, the user can give feedback based on these indicators to determine quantifiable quality of experience information, so that the multicast prediction model may perform predictions.

In example embodiments of the present disclosure, the multicast prediction model is retrained based on the extracted feature information and quality of experience information and the multicast access strategy, to be updated.

As mentioned above, after receiving a sufficient amount of data (for example, a period of data), the dynamic model updating strategy based on the feedback mechanism may make the multicast prediction model more accurate.

According to another aspect of the disclosure, a device for transmitting video data is provided. The device includes: at least one processor configured to layer an original video into a plurality of video data streams; embed extended information in at least one data packet of at least one video data stream among the plurality of video data streams, the extended information includes feature information of a preset video data stream; transmit the plurality of video data streams to corresponding channels respectively for transmitting.

In example embodiments of the present disclosure, the at least one processor is configured to layer the original video into a base layer video data stream and one or more enhancement layer video data streams, and the at least one processor is configured to embed the extended information at least in at least one data packet of the base layer video data stream.

In example embodiments of the present disclosure, the information embedding module is configured to embed the extended information in the at least one data packet of the base layer video data stream, the extended information includes feature information of the base layer video data stream and feature information of at least one enhancement layer video data stream.

In example embodiments of the present disclosure, the at least one processor is configured to: embed the extended information in the at least one data packet of the base layer video data stream, the extended information includes feature information of the base layer video data stream and feature information of an enhancement layer video data stream adjacent to the base layer video data stream; and embed the extended information in at least one data packet of each enhancement layer video data stream, the extended information for each enhancement layer video data stream includes feature information of the enhancement layer video data stream itself and feature information of a video data stream adjacent to the enhancement layer video data stream.

In example embodiments of the present disclosure, the feature information of each video data stream includes at least one type of a transmission rate of a video data stream, a proportion of data size of the video data stream to data size of a base layer video data stream, and a proportion of the data size of the video data stream to a sum of data sizes of the remaining video data streams.

In example embodiments of the present disclosure, the extended information further includes at least one of a first identifier for indicating that the data packet is embedded with the extended information, a number of video data streams corresponding to the feature information included in the extended information, a number of types of the feature information in the extended information and a embedding mode of the extended information.

According to another aspect of the disclosure, a device for receiving video data is provided. The device includes: at least one processor configured to receive video data streams corresponding to a currently accessed multicast combination, wherein at least one data packet of at least one video data stream in the corresponding video data streams is embedded with extended information, and the extended information includes feature information of a preset video data stream; extract the feature information from the extended information; acquire quality of experience information of a currently played video based on the video; obtain a multicast access strategy using a multicast prediction model, based on the extracted feature information and the quality of experience information; and adjust the currently accessed multicast combination based on the multicast access strategy.

In example embodiments of the present disclosure, the corresponding video data streams include a base layer video data stream; or the corresponding video data streams include the base layer video data stream and one or more enhancement layer video data streams, wherein the extended information is embedded at least in at least one data packet of the base layer video data stream.

In example embodiments of the present disclosure, the extended information is embedded in the at least one data packet of the base layer video data stream, the extended information includes feature information of the base layer video data stream and feature information of at least one enhancement layer video data stream.

In example embodiments of the present disclosure, the extended information is embedded in the at least one data packet of the base layer video data stream, the extended information includes feature information of the base layer video data stream and feature information of an enhancement layer video data stream adjacent to the base layer video data stream; and the extended information is embedded in at least one data packet of each enhancement layer video data stream among the one or more enhancement layer video streams, the extended information for each enhancement layer video data stream includes feature information of the enhancement layer video data stream itself and feature information of a video data stream adjacent to the enhancement layer video data stream.

In example embodiments of the present disclosure, the feature information extracted from the extended information includes at least one type of a transmission rate of a video data stream, a proportion of data size of the video data stream to data size of a base layer video data stream, and a ratio of the data size of the video data stream to a sum of data sizes of the remaining video data streams.

In example embodiments of the present disclosure, the extended information further includes at least one of a first identifier for indicating that the data packet is embedded with the extended information, a number of video data streams corresponding to the feature information included in the extended information, a number of types of the feature information in the extended information and a embedding mode of the extended information.

In example embodiments of the present disclosure, the at least one processor is configured to perform any one of the following operations: newly accessing at least one multicast other than the multicast combination currently accessed by the terminal device; exiting at least one multicast in the multicast combination currently accessed by the terminal device; remaining the current multicast combination accessed by the terminal device unchanged.

In example embodiments of the present disclosure, the quality of experience information includes at least one type of a jitter duration, an average codec bit rate and a frame rate deviation.

In example embodiments of the present disclosure, the at least one processor is further configured to retraining the multicast prediction model based on the extracted feature information and quality of experience information and the multicast access strategy, to be updated.

According to another aspect of the disclosure, a server including at least one processor and at least one memory storing instructions is provided, wherein the instructions, when executed by the at least one processor, cause the at least one processor to execute the above method for transmitting video data.

According to another aspect of the disclosure, a terminal device including at least one processor and at least one memory storing instructions is provided, wherein the instructions, when executed by the at least one processor, cause the at least one processor to execute the above method for receiving video data.

According to another aspect of the disclosure, a computer-readable storage medium storing instructions is provided, wherein the instructions, when executed by at least one processor of a server, cause the at least one processor to perform the above method for transmitting video data.

According to another aspect of the disclosure, a computer-readable storage medium storing instructions is provided, wherein the instructions, when executed by at least one processor of a server, cause the at least one processor to perform the above method for receiving video data.

The disclosure provides methods for transmitting and receiving video data, and a terminal device and a server. The server layers an original video into a plurality of video data streams, embeds extended information including feature information of a video data stream in a specified video data stream and transmits the plurality of video data streams to corresponding channels respectively for transmitting. A multicast prediction model in the terminal device may output a multicast access strategy based on the feature information of the video data stream and user experience information of the currently played video, and then a multicast combination currently accessed by the terminal device is adjusted based on the multicast access strategy to obtain a better multicast combination in the current network transmission environment, such that video data streams of corresponding quantities and quality are received. The above methods executed by the server and the terminal device can realize control of network congestion without increasing bandwidth consumption.

In addition, the multicast prediction model has good accuracy and robustness, and may accurately output corresponding multicast access strategies in different application environments (such as different network transmission environments, different video content or different user experience information), and also reduce meaningless trial-and-error actions for accessing or exiting multicasts, thereby saving computing resources of the terminal device and reducing the pressure on upper-layer routing caused by accessing or exiting multicasts.

In addition, the terminal device may access different multicast combinations to obtain videos of different qualities, which increases selection scenarios for video quality.

### BRIEF DESCRIPTION OF THE DRAWINGS

The detailed description of the disclosure will be given below in conjunction with the accompanying drawings. The above features and other objectives, characteristics and advantages of the disclosure will become clearer, in which:

FIG. 1 is a diagram of an application scenario of a method for transmitting video data and a method for receiving video data provided by example embodiments of the present disclosure;

FIG. 2 shows a flowchart of a method for transmitting video data provided by example embodiments of the present disclosure;

FIG. 3 shows a schematic diagram of extended information in a data packet provided by example embodiments of the present disclosure;

FIG. 4 shows a flowchart of a method for receiving video data provided by example embodiments of the present disclosure;

FIG. 5 shows a schematic diagram of a method for a terminal device to perform an adjustment of a multicast combination to be accessed based on a key frame data packet trigger provided by example embodiments of the present disclosure;

FIG. 6 shows a schematic diagram of a correspondence between information groups and label information for training a multicast prediction model provided by example embodiments of the present disclosure;

FIG. 7 shows a block diagram of a transmitting device for video data provided by example embodiments of the present disclosure;

FIG. 8 shows a block diagram of a receiving device for video data provided by example embodiments of the present disclosure.

### DETAILED DESCRIPTION

Hereinafter, example embodiments of the present disclosure will be described in detail with reference to the drawings. Among them, the same reference numerals always indicate the same parts.

Example embodiments of the present disclosure provide a method of transmitting video data and a method of receiving video data, wherein the method of transmitting video data may be executed by a server, and the method of receiving video data may be executed by a terminal device. The above methods may be applied in video services, for example, they may be applied in the Evolved Multimedia Broadcast/Multicast Service (EMBMS).

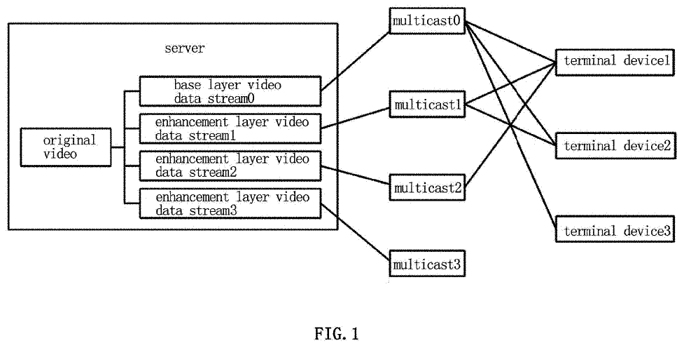

FIG. 1 is a diagram of an application scenario of a method for transmitting video data and a method for receiving video data provided by example embodiments of the present disclosure.

Referring to FIG. 1, a server layers original video data into a plurality of video data streams, embeds extended information including feature information of a video data stream in a specified video data stream, and then transmits the plurality of video data streams to corresponding multicasts. A multicast prediction model in a terminal device may output a multicast access strategy based on the feature information of the video data stream and user experience information of the currently played video, and then a multicast combination currently accessed by the terminal device is adjusted based on the multicast access strategy to obtain a better multicast combination in the current network transmission environment, such that video data streams of corresponding quantities and quality are received. The above methods executed by the server and the terminal device can realize control of network congestion without increasing bandwidth consumption.

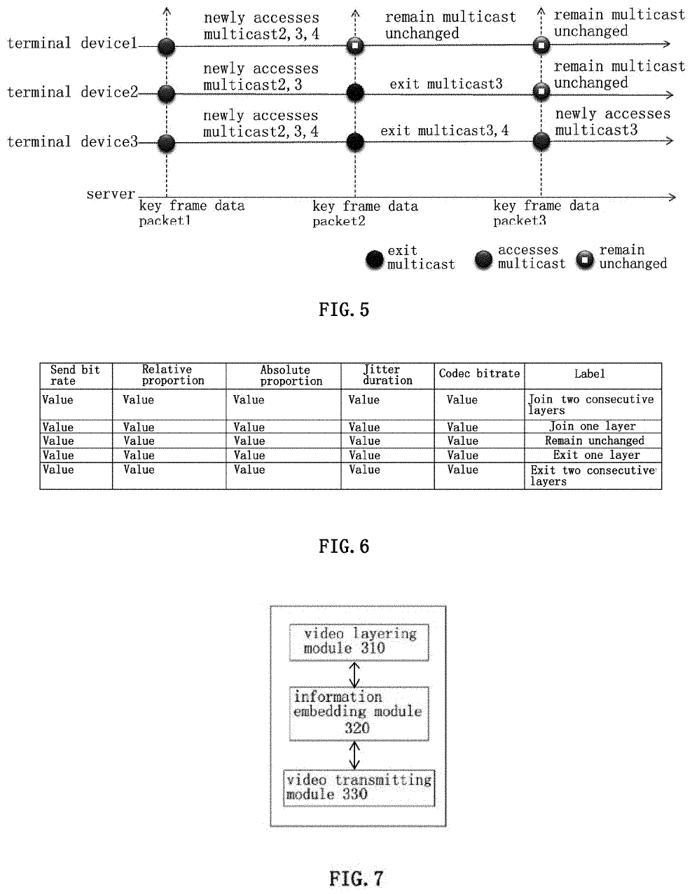

Herein, the multicast access strategy may be understood as a scheme of performing optimized selection on multiple multicasts included in the multicast combination, which is made for the terminal device based on the feature information of the video stream and the user experience information of the currently played video, wherein the selection includes access, exit or remain. The goal of the optimized selection enables the terminal device to have a good capability of receiving a video data stream, thereby enhancing the user experience. The specific details of the multicast access strategy will be described below in conjunction with FIG. 5.

The multicast prediction model is a machine learning model that has been trained. Here, the machine learning model may be obtained by performing training based on any available initial model, where the initial model may include, but is not limited to, a supervised learning-based multi-classification model, a support vector machine, an artificial neural network model, or a random forest model. The model may be run in the terminal device and may be trained based on a training dataset. The training data can include feature information of video streams, user experience information of videos, and corresponding multicast access strategies. The specific training process will be described below. In addition, the multicast prediction model has good accuracy and robustness, and may accurately output corresponding multicast access strategies in different application environments (such as different network transmission environments, different video content or different user experience information), and also reduce meaningless trial-and-error actions for accessing or exiting multicasts, thereby saving computing resources of the terminal device and reducing the pressure on upper-layer routing caused by accessing or exiting multicasts.

In addition, the terminal device may access different multicast combinations to obtain videos of different qualities, which increases selection scenarios for video quality.

The following describes specific operations of the method for transmitting video data provided by example embodiments of the present disclosure

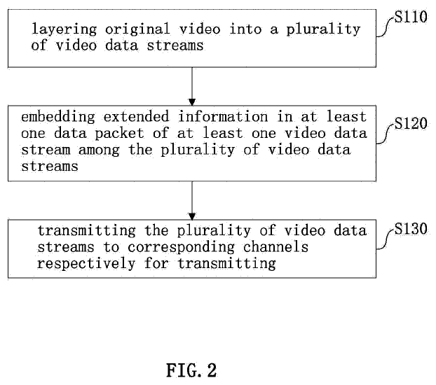

FIG. 2 shows a flowchart of a method for transmitting video data provided by example embodiments of the present disclosure.

Referring to FIG. 2, in operation S110, a server layers an original video into a plurality of video data streams.

In operation S110, the server may layer the original video into the plurality of video data streams based on related video layering technologies (such as a layered video multicast technology), and the number of the video data streams formed after the original video is layered may be determined based on actual demand.

It should be noted here that the plurality of video data streams may be enhanced with each other, and during transmission, the plurality of video data streams are independent of each other and enhanced with each other. The sum of bandwidths occupied by the transmission of the plurality of video data streams corresponds to the maximum rate that may be obtained by a terminal device downstream of this path. The terminal device may receive at least one video data stream among the plurality of video data streams. When the number of the video data streams received by the terminal device changes, the quality of the video played by the terminal device also changes. For example, when the number of the video data streams received by the terminal device increases, the resolution of the video played by the terminal device becomes higher; when the number of the video data streams received by the terminal device decreases, the resolution of the video played by the terminal device becomes lower.

In example embodiments of the present disclosure, operation S110 may include that the server layers the original video into a base layer video data stream and one or more enhancement layer video data streams.

The base layer video data stream may be independently decoded to provide a basic video quality. The enhancement layer video data stream needs to be decoded together with the base layer video data stream, the enhancement layer video data stream may provide a higher video quality. It should be noted that the video data streams received by the terminal device at least includes the base layer video data stream.

When the terminal device only receives the base layer video data stream, the video played by the terminal device has the basic quality; when the terminal device receives the base layer video data stream and at least one enhancement layer video data stream, the video may have a higher quality, and as the number of enhancement layer video data streams received by the terminal device increases, the quality of the video may also be improved.

Taking the resolution of the video as an example, in example embodiments of the present disclosure, as shown in FIG. 1, the server layers the original video into a base layer video data stream 0, an enhancement layer video data stream 1, an enhancement layer video data stream 2, and an enhancement layer video data stream 3. The video resolutions may be divided into a 360P, a 480P, a 720P and a 1080P.

The base layer video data stream 0 may provide a video quality with a resolution of 360P, the base layer video data stream 0 and the enhancement layer video data stream 1 together provide a video quality with a resolution of 480P, the base layer video data stream 0, the enhancement layer video data stream 1 and the enhancement layer video data stream 2 together provide a video quality with a resolution of 720P, and the base layer video data stream 0, the enhancement layer video data stream 1, the enhancement layer video data stream 2 and the enhancement layer video data stream 3 together provide a video quality with a resolution of 1080P.

In operation S120, the server embeds extended information in at least one data packet of at least one video data stream among the plurality of video data streams. Here, the extended information includes feature information of a preset video data stream.

It should be understood that a video data stream is transmitted in the form of a data packet, each video data stream may include a plurality of data packets, and the extended information may be embedded in any data packet of any video data stream. Alternatively, a number of video data streams and a number of data packets used to embed the extended information may be determined according to actual demand, for example, the extended information is embedded in one or more data packets of a specified video data stream, or, the extended information is embedded in one or more data packets of a plurality of specified video data streams, respectively. For example, the extended information is only embedded in the fifth data packet of a certain video data stream, or the extended information is embedded in the first, fourth, seventh, and tenth data packets of a certain video data stream.

In example embodiments of the present disclosure, operation S120 may include that extended information is embedded at least in at least one data packet of the base layer video data stream.

As mentioned above, the video data streams received by the terminal device include at least the base layer video data stream. Therefore, embedding the extended information in the data packet of the base layer video data stream may ensure that each terminal device may receive the extended information.

In example embodiments of the present disclosure, operation S120 may include that the server embeds the extended information in at least one data packet of the base layer video data stream, the extended information includes feature information of the base layer video data stream, and feature information of at least one enhancement layer video data stream.

The extended information embedded in the data packet of the base layer video data stream may be the feature information of the base layer video data stream and feature information of a part of the enhancement layer video data streams, or may be the feature information of the base layer video data stream and feature information of all the enhancement layer video data streams.

For example, the extended information embedded in the data packet of the base layer video data stream 0 may include feature information of the base layer video data stream 0 and feature information of the enhancement layer video data stream 1; or the extended information embedded in the data packet of the base layer video data stream 0 may include the feature information of the base layer video data stream 0 and feature information of the enhancement layer video data stream 1 to the enhancement layer video data stream 4.

In example embodiments of the present disclosure, operation S120 may include that the extended information embedded in at least one data packet of the base layer video data stream includes the feature information of the base layer video data stream, and feature information of an enhancement layer video data stream adjacent to the base layer video data stream; and the extended information embedded in at least one data packet of each enhancement layer video data stream includes feature information of the enhancement layer video data stream itself, and feature information of a video data stream adjacent to the enhancement layer video data stream. It needs to be explained that the “adjacent” refers to adjacent in a logical order of layering the original video. For example, an original video is layered into 4 layers, for example, including a base layer 0, an enhancement layer 1, an enhancement layer 2, and an enhancement layer 3. Among them, an enhancement layer adjacent to the base layer 0 may be the enhancement layer 1, and an enhancement layer adjacent to the enhancement layer 2 may be the enhanced layer 1 and the enhanced layer 3.

As an example, the base layer video data stream 0, the enhancement layer video data stream 1, the enhancement layer video data stream 2, and the enhancement layer video data stream 3 are sequentially adjacent. The extended information embedded in the data packet of the base layer video data stream 0 may include the feature information of the base layer video data stream 0 and the feature information of the enhancement layer video data stream 1; the extended information embedded in the data packet of the enhancement layer video data stream 1 may include the feature information of the enhancement layer video data stream 1, and the feature information of the base layer video data stream 0 and/or the feature information of the enhancement layer video data stream 2; the extended information embedded in the data packet of the enhancement layer video data stream 2 may include the feature information of the enhancement layer video data stream 2, and the feature information of the enhancement layer video data stream 1 and/or the enhancement layer video data stream 3, and so on.

In example embodiments of the present disclosure, the feature information of each video data stream includes at least one of a transmission rate of a video data stream, a proportion of data size of the video data stream to data size of the base layer video data stream, a proportion of the data size of the video data stream to the sum of data sizes of the remaining video data streams.

Referring to FIG. 1, taking the base layer video data stream 0 as an example, the feature information of the base layer video data stream 0 may include a transmission rate of the base layer video data stream 0, a proportion of the data size of the base layer video data stream 0 to its own data size (it may be understood that the proportion is 1) and a proportion of the data size of the base layer video data stream 0 to the sum of the data size of the remaining video data streams (that is, the enhancement layer video data stream 1 to the enhancement layer video data stream 3).

Taking the enhancement layer video data stream 1 as an example, the feature information of the enhancement layer video data stream 1 may include a transmission rate of the enhancement layer video data stream 1, a proportion of the data size of the enhancement layer video data stream 1 to the data size of the base layer video data stream 0, and a proportion of the data size of the enhancement layer video data stream 1 to the sum of the data sizes of the remaining video data streams (that is, the base layer video data stream 0, the enhancement layer video data stream 2, and the enhancement layer video data stream 3).

It may be understood that, in the data packet embedded with the extended information, the feature information of the video data stream may include one or more of the above three types of feature information.

In example embodiments of the present disclosure, the extended information further includes at least one of a first identifier used to indicate a data packet is embedded with the extended information, a number of video data streams corresponding to the feature information contained in the extended information, a number of types of the feature information in the extended information, and a embedding method of extended information.

It should be noted here that in example embodiments of the present disclosure, the extended information may be embedded in the header of the data packet, and the first identifier of the extended information is a preset value. When the header of the data packet has the first identifier, it indicates that the data packet is embedded with the extended information.

In example embodiments of the present disclosure, extended information in one data packet may include feature information of at least one video data stream. As an example, when extended information in one data packet includes feature information of one video data stream, a number of video data streams corresponding to the feature information is 1; when extended information in one data packet includes feature information of two video data streams, a number of video data streams corresponding to the feature information is 2; and so on, when extended information in one data packet includes feature information of n video data streams, a number of video data streams corresponding to the feature information is n, n is a positive integer.

In extended information in one data packet, the type and quantity of feature information of each video data stream are the same. As mentioned above, the types of feature information of the video data stream include a transmission rate of the video data stream, a proportion of the data size of the video data stream to the data size of the base layer video data stream, and a proportion of the data size of the video data stream and the sum of the data sizes of the remaining video data streams. Therefore, in example embodiments of the present disclosure, the number of types of the feature information in the extended information may be 1, 2, or 3.

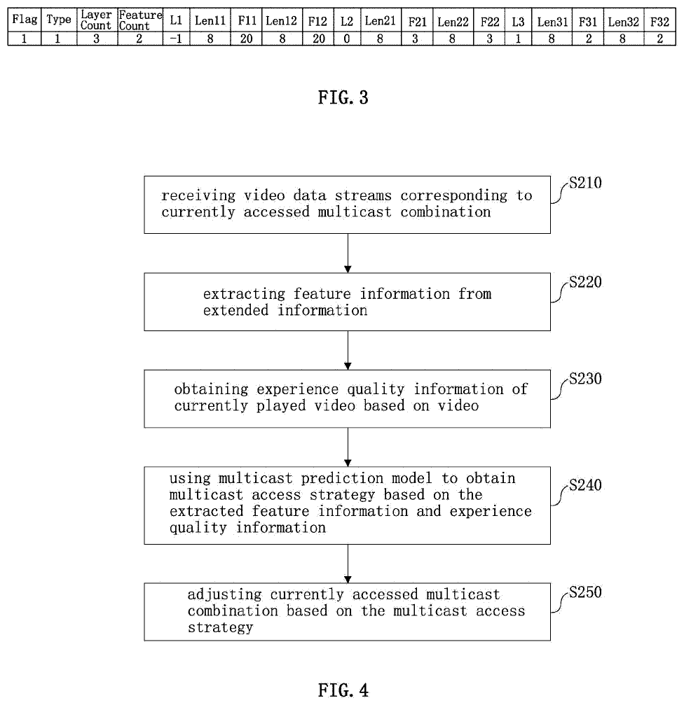

FIG. 3 shows a schematic diagram of extended information in a data packet provided by example embodiments of the present disclosure.

The following takes FIG. 3 as an example to give an example introduction to the extended information.

Referring to FIG. 3, when a value of Flag is 1, it represents a first identifier. When the value of Flag is 0, the other items in FIG. 3 are all empty, it represents that no extended information is embedded in the data packet.

A value of Type may represent an embedded mode of the extended information. For example, when the value of Type is 1, it may represent a first embedded mode where data packets of a base layer video data stream and data packets of each enhancement layer video data stream are respectively embedded with the extended information; When the value of Type is 2, it may represent a second embedded mode where only the data packets of the base layer video data stream are embedded with the extended information.

A value of Layer Count represents a number of video data streams corresponding to feature information contained in the extended information.

A value of Feature Count represents a number of types of the feature information in the extended information.

Li is used to distinguish different video data streams corresponding to the feature information contained in the extended information. As shown in FIG. 3, the value of Layer Count is 3, and the number of video data streams corresponding to the feature information contained in the extended information is 3, and L1, L2, and L3 represent there video data streams respectively.

A value of Li represents a relationship between a video data stream represented by Li and a video data stream where the extended information is located. When Li is 0, the video data stream represented by Li is the video data stream where the extended information is located; when Li is −1, the video data stream represented by Li is one video data stream previous to the video data stream where the extended information is located; when Li is 1, the video data stream represented by Li is one video data stream next to the video data stream where the extended information is located.

It may be understood that when Li is −n, the video data stream represented by Li is n video data streams previous to the video data stream where the extended information is located; when Li is n, the video data stream represented by Li is n video data streams next to the video data stream where the extended information is located, n is a positive integer.

Referring to FIG. 3, the value of L2 is 0, it indicates that the enhancement layer video data stream 2 is the video data stream where the extended information is located; the value of L1 is −1, it indicates that the enhancement layer video data stream 1 is one video data stream previous to the enhancement layer video data stream 2; the value of L3 is 1, it indicates that the enhancement layer video data stream 3 is one video data stream next to the enhancement layer video data stream 2.

A value of Lenij represents the byte length of the j-th feature information of the video data stream represented by Li. Among them, i and j are both positive integers.

Referring to FIG. 3, for example, the value of Len11 is the byte length of the transmission rate of the enhancement layer video data stream 1.

A value of Fij represents the value of the j-th feature information of the video data stream represented by Li. Among them, i and j are both positive integers.

Referring to FIG. 3, for example, the value of F11 is the value of the transmission rate of the enhancement layer video data stream 1.

In operation S130, the server transmits the plurality of video data streams to corresponding channels respectively for transmitting.

It may be understood that there is a one-to-one correspondence between video data streams and multicasts. The server uses a preset communication protocol to transmit each video data stream to the corresponding multicast through the corresponding channel. The preset communication protocol may include a FLUTE protocol and a LCT protocol, etc.

Taking FIG. 1 as an example, the server transmits the base layer video data stream 0 to a multicast 0 through a channel 0, the server transmits the enhancement layer video data stream 1 to a multicast 1 through a channel 1, the server transmits the enhancement layer video data stream 2 to a multicast 2 through a channel 2, and the server transmits the enhancement layer video data stream 3 to a multicast 3 through a channel 3.

The terminal device may access the corresponding multicast to receive the corresponding video data stream. For example, the terminal device may receive the base layer video data stream 0 when it accesses the multicast 0, and the terminal device may receive the base layer video data stream 0 and the enhancement layer video data stream 1 when it the multicast 0 and the multicast 1.

As mentioned above, the server layers the original video into the plurality of video data streams, and may transmit the video data to the multicast group addresses hierarchically through the corresponding channels. The data of different video data streams is independent with each other, compared with the existing multi-video stream repeated multicast solution, the total bandwidth of output transmission will not increase, and the network bandwidth utilization efficiency of the layered video multicast is greatly improved. In addition, by embedding the extended information (feature information), it may be convenient for the receiver analyzing and predicting the multicast access strategy based on the extended information.

The following describes specific operations of a method for receiving video data provided by example embodiments of the present disclosure.

FIG. 4 shows a flowchart of a method for receiving video data provided by example embodiments of the present disclosure.

Referring to FIG. 4, in operation S210, a terminal device receives video data streams corresponding to a currently accessed multicast combination.

Here, at least one data packet of at least one video data stream in the corresponding video data streams is embedded with extended information, and the extended information includes feature information of a preset video data stream.

It should be noted herein that one multicast combination may include at least one multicast. As mentioned above, the terminal device may receive at least one video data stream among the plurality of video data streams. When the number of the video data streams received by the terminal device changes, the quality of the video played by the terminal device also changes. Therefore, the terminal device may receive different video data streams by accessing different multicast combinations, thereby obtaining different video qualities.

Alternatively, in operation S210, the multicast combination currently accessed by the terminal device may be a default multicast combination, or a multicast combination determined based on the user's selection of a video quality. In operation S210, the multicast combinations accessed by different terminal devices may be the same or different.

Taking FIG. 1 as an example, the multicast combination currently accessed by the terminal device 1 includes the multicast 0, the multicast 1 and the multicast 2, and the terminal device 1 may receive the base layer video data stream 0, the enhancement layer video data stream 1, and the enhancement layer video data stream 2; the multicast combination currently accessed by the terminal device 2 includes the multicast 0 and the multicast 1, and the terminal device 2 may receive the basic layer video data stream 0 and the enhancement layer video data stream 1; the multicast combination currently accessed by the terminal device 3 includes the multicast 0, the terminal device 3 may receive the base layer video data stream 0.

Alternatively, the corresponding video data streams include a base layer video data stream; or the corresponding video data streams include a base layer video stream and one or more enhancement layer video data streams, wherein at least one data packet of the base layer video data stream is embedded with the extended information. In operation S210, the multicast combination accessed by the terminal device includes at least the multicast corresponding to the base layer video data stream, so as to ensure that all the terminal devices may receive the extended information.

In operation S220, the terminal device extracts the feature information from the extended information.

It may be understood that the extended information is embedded in any data packet of the video data stream, and the video data stream is transmitted in the form of data packets. When the terminal device receives a data packet with the extended information based on the video data stream corresponding to the multicast combination that it accesses, the feature information is extracted from the extended information of the data packet.

As mentioned above, in example embodiments of the present disclosure, the extended information may be embedded in two ways.

The first embedded way is that a data packet of a base layer video data stream and a data packet of at least one enhancement layer video data stream are respectively embedded with the extended information. That is, at least one data packet of the base layer video data stream is embedded with feature information of the base layer video data stream and feature information of an enhancement layer video data stream adjacent to the base layer video data stream.

At least one data packet of each enhancement layer video data stream in the one or more enhancement layer video streams is embedded with the extended information, and the extended information includes feature information of the enhancement layer video data stream itself, and feature information of a video data stream adjacent to the enhancement layer video data stream.

The second embedded way is that only a data packet of the base layer video data stream is embedded with the extended information. That is, the embedding the extended information at least in the at least one data packet of the base layer video data stream includes embedding the extended information in the at least one data packet of the base layer video data stream, the extended information includes the feature information of the base layer video data stream and feature information of at least one enhancement layer video data stream.

For a data packet embedded with extended information obtained by any embedded way, when the terminal device receives the data packet, it may extract the feature information from the extended information of the data packet.

Alternatively, the feature information extracted by the terminal device from the extended information includes at least one type of a transmission rate of the video data stream, a proportion of data size of the video data stream to data size of the base layer video data stream, and a proportion of the data size of the video data stream to the sum of the data sizes of the remaining video data streams.

In operation S230, the terminal device obtains quality of experience information of the currently played video based on the video.

The quality of experience information generally refers to Quality of Experience (QoE), that is, the user's comprehensive subjective perception of the quality and performance (including effectiveness and usability, etc.) of a device, a network, a system, an application, or a service. In example embodiments of the present disclosure, the quality of experience information is information that may be extracted and quantified based on the currently played video.

The quality of experience information includes at least one type of a jitter duration, an average codec bit rate, a frame rate deviation.

The following explains each type of quality of experience information.

When an absolute difference between an actual playback time and an expected playback time is greater than a predefined value (100 milliseconds), jitter may occur, and a duration of the jitter is the jitter duration. The average codec bit rate is a proportion of a size of a video file to a time it takes to play the video file. The frame rate deviation represents a time difference between an actual playback time of a certain frame in a video and an expected playback time of the frame.

It should be noted here that the quality of experience information extracted in operation S230 includes at least one of the above three types of quality of experience information.

In operation S240, the terminal device uses a multicast prediction model to obtain a multicast access strategy based on the extracted feature information and quality of experience information.

It may be understood that the multicast prediction model is a machine learning model that has been trained, and the model may be run in the terminal device. In operation S240, the extracted feature information and quality of experience information are used as the input of the model, so that the multicast prediction model can output the multicast access strategy, and the multicast access strategy is used to indicate an adjustment way of the multicast combination.

It should be noted here that the multicast prediction model may be preset in the terminal device, and the multicast prediction model can also be downloaded by the terminal device in a designated device. For example, the server shown in FIG. 1 stores a multicast prediction model, and when the terminal device is connected to the server for the first time, the multicast prediction model is downloaded.

In operation S250, the terminal device adjusts the currently accessed multicast combination based on the multicast access strategy.

In example embodiments of the present disclosure, operation S250 may be any one of the following operations:

Operation (a1): at least one multicast other than the multicast combination currently accessed by the terminal device is newly accessed;

For example, the multicast combination currently accessed by the terminal device 1 includes the multicast 0, the multicast 1, and the multicast 2, and the terminal device 1 may newly access the multicast 3 on the basis of the currently accessed multicast combination.

Operation (a2): at least one multicast in the multicast combination currently accessed by the terminal device is exited;

For example, the multicast combination currently accessed by the terminal device 1 includes the multicast 0, the multicast 1, and the multicast 2, and the terminal device 1 may exit the multicast 2 on the basis of the currently accessed multicast combination.

Operation (a3): the multicast combination currently accessed by the terminal device remains unchanged.

For example, the multicast combination currently accessed by terminal device 1 includes the multicast 0, the multicast 1, and the multicast 2, and the terminal device 1 remains the currently accessed multicast combination unchanged.

In example embodiments of the present disclosure, the data packet embedded with the extended information may be referred to as a key frame data packet. It may be understood that each time a key frame data packet is received by the terminal device, operation S220 to operation S250 may be performed once. That is, each time the terminal device receives a key frame data packet, the terminal device adjusts the currently connected multicast combination once.

As described above, the terminal device may obtain the feature information by receiving the video data stream, combine the feature information with the quality of experience information of the video, and use the multicast prediction model to obtain the multicast access strategy, which can more accurately guide the execution of joining/exiting actions, achieve the optimal processing of joining and exiting multicasts, greatly reduce meaningless trial-and-error actions for joining or exiting multicasts, thereby not only saving computing resources of the terminal device while reducing the pressure on upper-layer routing caused by joining or exiting multicasts. In this way, the receiver-driven hierarchical congestion control is realized without increasing bandwidth consumption, and the user experience is improved. On the other hand, since the accuracy and robustness of the multicast prediction model, the problem that the layered video multicast technology cannot cover more application scenarios due to the branch coverage of the existing trial-and-error action logic judgment is not accurate enough is avoided in the term of the technical realization principle.

FIG. 5 shows a schematic diagram of a method for a terminal device to perform an adjustment of a multicast combination to be accessed based on a key frame data packet trigger provided by example embodiments of the present disclosure.

Referring to FIG. 5, a server sequentially transmits a key frame data packet 1, a key frame data packet 2, and a key frame data packet 3 at different time points.

A terminal device 1 initially accesses a multicast 0 and a multicast 1. When the terminal device 1 receives the key frame data packet 1, it newly accesses a multicast 2, a multicast 3 and a multicast 4; when the terminal device 1 receives the key frame data packet 2, the currently accessed multicast combination remains unchanged; when the terminal device 1 receives the key frame data packet 3, the currently accessed multicast combination remains unchanged.

A terminal device 2 initially accesses the multicast 0 and the multicast 1. When the terminal device 2 receives the key frame data packet 1, it newly accesses the multicast 2 and the multicast 3; when the terminal device 2 receives the key frame data packet 2, it exits the multicast 3; when the terminal device 2 receives the key frame data packet 3, the currently accessed multicast combination remains unchanged.

A terminal device 3 initially accesses the multicast 0 and the multicast 1. When the terminal device 3 receives the key frame data packet 1, it newly accesses the multicast 2, the multicast 3 and the multicast 4; when the terminal device 3 receives the key frame data packet is 2, it exits the multicast 3 and the multicast 4; when the terminal device 3 receives the key frame data packet 3, it newly accesses the multicast 3.

In example embodiments of the present disclosure, the multicast prediction model may be retrained based on the extracted feature information and the quality of experience information and the multicast access strategy, to be updated.

The following describes a training process of the multicast prediction model:

Operation (b1): multiple feature information combinations are obtained based on multiple original videos with different content sizes, multiple quality of experience information combinations are set, and each feature information combination is respectively combined with each quality of experience information combination to form multiple information groups.

FIG. 6 shows a schematic diagram of a correspondence between information groups and label information for training a multicast prediction model provided by example embodiments of the present disclosure.

As shown in FIG. 6, each information group includes at least one type of feature information and at least one type of quality of experience information. Each row in FIG. 6 represents an information group, and an end of each row is the label information (Label) of the information group.

As shown in FIG. 6, the types of feature information include a transmission rate of a video data stream (represented by “Send bit rate” in FIG. 6), a proportion of data size of a video data stream to data size of a base layer video data stream (represented by “Relative proportion” in FIG. 6), a proportion of the data size of the video data stream to the sum of data sizes of the remaining video data streams (represented by “Absolute proportion” in FIG. 6). The quality of experience information includes a jitter duration (represented by “Jitter duration” in FIG. 6), an average codec bitrate (represented by “Codec bitrate” in FIG. 6), and frame rate deviation (not shown in FIG. 6).

As shown in FIG. 6, the types of quality of experience information include the jitter duration, the average codec bit rate and the frame rate deviation.

Operation (b2): the label information is marked for each information group.

The label information indicates a multicast access strategy corresponding to an information group. As shown in FIG. 6, the label information may be “Join two consecutive layers” (e.g., access to two consecutive video layer data streams), “Join one layer” (e.g., access to one video layer data stream), “Remain unchanged” (e.g., maintain unchanged), “Exit one layer” (e.g., exit one video layer data stream), “Exit two consecutive layers” (e.g., exit two consecutive video layer data streams).

Operation (b3): each information group and its label information are used as training data to train an initial multicast prediction model.

Among them, the multicast prediction model may be a supervised learning-based multi-classification model, and machine learning algorithms such as support vector machine, artificial neural network or random forest may be used to train the multicast prediction model.

The following takes the terminal device 1 in FIG. 1 as an example to introduce a process of transmitting and receiving video data.

Operation (d1): the server layers the original video into the base layer video data stream 0, the enhancement layer video data stream 1, the enhancement layer video data stream 2, and the enhancement layer video data stream 3.

Operation (d2): the server embeds the extended information in at least one data packet of the base layer video data stream 0, the enhancement layer video data stream 1, the enhancement layer video data stream 2, and the enhancement layer video data stream 3, respectively.

The extended information embedded in the data packet of the base layer video data stream 0 includes the feature information of the base layer video data stream 0 and the feature information of the enhancement layer video data stream 1; the extended information embedded in the data packet of the enhancement layer video data stream 1 includes the feature information of the enhancement layer video data stream 1 and the feature information of the enhancement layer video data stream 2; the extended information embedded in the data packet of the enhancement layer video data stream 2 includes the feature information of the enhancement layer video data stream 2, the feature information of the enhancement layer video data stream 1 and the feature information of the enhancement layer video data stream 3; the extended information embedded in the data packet of enhancement layer video data stream 3 includes the feature information of the enhancement layer video data stream 2 and the feature information of the enhancement layer video data stream 3.

Operation (d3): the server transmits the base layer video data stream 0 to the multicast 0 through the channel 0, the server transmits the enhancement layer video data stream 1 to the multicast 1 through the channel 1, and the server transmits the enhancement layer video data stream 2 to the multicast 2 through the channel 2, and the server transmits the enhancement layer video data stream 3 to the multicast 3 through the channel 3.

Operation (d4): the terminal device 1 receives the video data streams corresponding to the currently accessed multicast combination.

For example, the multicast combination currently accessed by the terminal device 1 includes the multicast 0, the multicast 1 and the multicast 2, and may receive the base layer video data stream 0, the enhancement layer video data stream 1 and the enhancement layer video data stream 2.

Operation (d5): the terminal device 1 receives the data packet embedded with the extended information in the enhancement layer video data stream 2. The extended information embedded in the data packet may include the feature information of the enhancement layer video data stream 2 and the feature information of the enhancement layer video data stream 1 and/or the enhancement layer video data stream 3.

Operation (d6): the terminal device 1 extracts the quality of experience information based on the currently played video.

Operation (d7): the terminal device 1 obtains the multicast access strategy by using the multicast prediction model, based on the extracted feature information and quality of experience information.

Operation (d8): the terminal device 1 adjusts the currently accessed multicast combination based on the multicast access strategy.

Specifically, the multicast combination currently accessed by the terminal device 1 includes the multicast 0, the multicast 1 and the multicast 2, and the terminal device 1 newly accesses the multicast 3 on the basis of the currently accessed multicast combination. The adjusted multicast combination includes the multicast 0, the multicast 1, the multicast 2, and the multicast 3.

In example embodiments of the present disclosure, the multicast prediction model may be retrained based on the extracted feature information and quality of experience information and the multicast access strategy, to be updated.

It may be understood that the feature information extracted in operation S220, the quality of experience information extracted in operation S230, and the multicast access strategy obtained in operation S240 are used as new training data to retrain the current multicast prediction model to further improve the accuracy of the prediction model.

Alternatively, the following operations may be used to retrain the multicast prediction model:

Operation (c1): the terminal device transmits the extracted feature information and the quality of experience information and the multicast access strategy to a preset device.

Operation (c2): the preset device uses the received feature information, quality of experience information and multicast access strategy as training data to retrain the multicast prediction model. Herein, the multicast prediction model in the preset device is the same as the multicast prediction model in the terminal device.

Operation (c3): the preset device transmits parameter information of the retrained multicast prediction model to the terminal device.

Operation (c4): the terminal device updates its multicast prediction model based on the received parameter information.

It should be noted here that the preset device may be the server shown in FIG. 1, or may be other servers or computer devices.

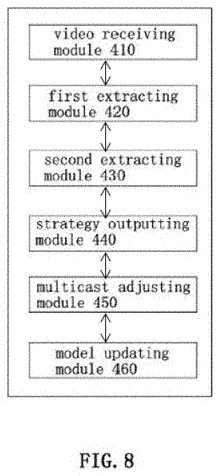

FIG. 7 shows a block diagram of a transmitting device for video data according to example embodiments of the present disclosure. Among them, functional units of the sending device for video data may be implemented by hardware, software, or a combination of hardware and software that implements the principles of the present disclosure. Those skilled in the art can understand that the functional units described in FIG. 7 may be combined or divided into sub-units to realize the principles of the present disclosure. Therefore, the description herein may support any possible combination, or division, or further limitation of the functional units described herein.

The following makes a brief description of the functional units that the transmitting device for video data may have and the operations that may be performed by each functional unit. For the details involved, the relevant description above may be referred, which will not be repeated here.

Referring to FIG. 7, the transmitting device for video data according to example embodiments of the present disclosure includes a video layering module 310, an information embedding module 320, and a video transmitting module 330.

The video layering module 310 is configured to layer an original video into a plurality of video data streams.

The information embedding module 320 is configured to embed extended information in at least one data packet of at least one video data stream among the plurality of video data streams, the extended information includes feature information of a preset video data stream.

The video transmission module 330 is configured to transmit the plurality of video data streams to corresponding channels respectively for transmitting.

In example embodiments of the present disclosure, the video layering module 310 is configured to layer the original video into a base layer video data stream and one or more enhancement layer video data streams, and the information embedding module 320 is configured to embed the extended information at least in at least one data packet of the base layer video data stream.

In example embodiments of the present disclosure, the information embedding module 320 is configured to embed the extended information in the at least one data packet of the base layer video data stream, the extended information includes feature information of the base layer video data stream and feature information of at least one enhancement layer video data stream.

In example embodiments of the present disclosure, the information embedding module 320 is configured to embed the extended information in the at least one data packet of the base layer video data stream, the extended information includes feature information of the base layer video data stream and feature information of an enhancement layer video data stream adjacent to the base layer video data stream; and embed the extended information in at least one data packet of each enhancement layer video data stream, the extended information for each enhancement layer video data stream includes feature information of the enhancement layer video data stream itself and feature information of a video data stream adjacent to the enhancement layer video data stream.

In example embodiments of the present disclosure, the feature information of each video data stream includes at least one type of a transmission rate of a video data stream, a proportion of data size of the video data stream to data size of a base layer video data stream, and a proportion of the data size of the video data stream to a sum of data sizes of the remaining video data streams.

In example embodiments of the present disclosure, the extended information further includes at least one of a first identifier for indicating that the data packet is embedded with the extended information, a number of video data streams corresponding to the feature information included in the extended information, a number of types of the feature information in the extended information and a embedding mode of the extended information.

FIG. 8 shows a block diagram of a receiving device for video data according to example embodiments of the present disclosure. Among them, functional units of the receiving device for video data may be implemented by hardware, software, or a combination of hardware and software that implements the principles of the present disclosure. Those skilled in the art can understand that the functional units described in FIG. 8 may be combined or divided into sub-units to realize the principles of the present disclosure. Therefore, the description herein may support any possible combination, or division, or further limitation of the functional units described herein.

The following makes a brief description of the functional units that the receiving device for video data may have and the operations that may be performed by each functional unit. For the details involved, the relevant description above may be referred, which will not be repeated here.

Referring to FIG. 8, a receiving device for video data according to example embodiments of the present disclosure includes a video receiving module 410, a first extracting module 420, a second extracting module 430, a strategy outputting module 440, and a multicast adjusting module 450.

The video receiving module 410 is configured to receive video data streams corresponding to a currently accessed multicast combination, wherein at least one data packet of at least one video data stream in the corresponding video data streams is embedded with extended information, and the extended information includes feature information of a preset video data stream.

The first extracting module 420 is configured to extract the feature information from the extended information.

The second extracting module 430 is configured to acquire quality of experience information of a currently played video based on the video.

The strategy outputting module 440 is configured to obtain a multicast access strategy using a multicast prediction model, based on the extracted feature information and the quality of experience information.

The multicast adjusting module 450 is configured to adjust the currently accessed multicast combination based on the multicast access strategy.

In example embodiments of the present disclosure, the corresponding video data streams include a base layer video data stream; or the corresponding video data streams include the base layer video data stream and one or more enhancement layer video data streams, wherein the extended information is embedded at least in at least one data packet of the base layer video data stream.

In example embodiments of the present disclosure, the extended information is embedded in the at least one data packet of the base layer video data stream, the extended information includes feature information of the base layer video data stream and feature information of at least one enhancement layer video data stream.

In example embodiments of the present disclosure, the extended information is embedded in the at least one data packet of the base layer video data stream, the extended information includes feature information of the base layer video data stream and feature information of an enhancement layer video data stream adjacent to the base layer video data stream; and the extended information is embedded in at least one data packet of each enhancement layer video data stream among the one or more enhancement layer video streams, the extended information for each enhancement layer video data stream includes feature information of the enhancement layer video data stream itself and feature information of a video data stream adjacent to the enhancement layer video data stream.

In example embodiments of the present disclosure, the feature information extracted from the extended information includes at least one type of a transmission rate of a video data stream, a proportion of data size of the video data stream to data size of a base layer video data stream, and a ratio of the data size of the video data stream to a sum of data sizes of the remaining video data streams.

In example embodiments of the present disclosure, the extended information further includes at least one of a first identifier for indicating that the data packet is embedded with the extended information, a number of video data streams corresponding to the feature information included in the extended information, a number of types of the feature information in the extended information and a embedding mode of the extended information.

In example embodiments of the present disclosure, the multicast adjusting module 450 is configured to perform any one of the following operations: newly accessing at least one multicast other than the multicast combination currently accessed by the terminal device; exiting at least one multicast in the multicast combination currently accessed by the terminal device; remaining the current multicast combination accessed by the terminal device unchanged.

In example embodiments of the present disclosure, the quality of experience information includes at least one type of a jitter duration, an average codec bit rate and a frame rate deviation.

In example embodiments of the present disclosure, the receiving device further includes a model updating module 460, and the model update module 460 is configured to retraining the multicast prediction model based on the extracted feature information and quality of experience information and the multicast access strategy, to be updated.

Example embodiments of the present disclosure also provide a server including at least one processor and at least one memory storing instructions, wherein, the instructions, when executed by the at least one processor, cause the at least one processor to execute the above method for transmitting video data.

Example embodiments of the present disclosure also provide a terminal device including at least one processor and at least one memory storing instructions, wherein the instructions, when executed by the at least one processor, cause the at least one processor to execute the above method for receiving video data.

The above processor may be a CPU (Central Processing Unit), a general-purpose processor, a DSP (Digital Signal Processor), an ASIC (Application Specific Integrated Circuit), an FPGA (Field-Programmable Gate Array) or other programmable logic devices, transistor logic devices, hardware components or any combination thereof. It may implement or execute various example logical blocks, modules and circuits described in conjunction with the disclosure. The processor may also be a combination of computing functions, for example, a combination of one or more microprocessors, a combination of a DSP and a microprocessor, and so on.

The memory may be a ROM (Read-Only Memory) or other types of static storage devices that may store static information and instructions, and may be a RAM (Random Access Memory) or other types of dynamic storage devices that may store information and instructions, and may also be a EEPROM (Electrically Erasable Programmable Read Only Memory), a CD-ROM (Compact Disc Read-Only Memory) or other optical disk storage, optical disk storage (including compact discs, laser discs, optical discs, digital versatile discs, Blue-ray discs, etc.), magnetic disk storage media or other magnetic storage devices, or may be any other media for carrying or storing desired program codes in the form of instructions or data structures and that may be accessed by a computer, but not limited to this.

Example embodiments of the present disclosure also provide a computer-readable storage medium storing instructions, wherein the instructions, when executed by at least one processor of a server, cause the at least one processor to execute the above method for transmitting video data.

Example embodiments of the present disclosure also provide a computer-readable storage medium storing instructions, wherein the instructions, when executed by at least one processor, cause the at least one processor to execute the above method for receiving video data.

The aforementioned computer-readable recording medium is any data storage that may store data read by a computer system. Examples of the computer-readable recording medium include a read-only memory, a random access memory, a read-only optical disk, a magnetic tape, a floppy disk, an optical data storage, and carrier waves (such as data transmission through the Internet via a wired or wireless transmission path).

Although the present disclosure has been shown and described with reference to specific example embodiments of the present disclosure, those skilled in the art will understand that various changes in various forms and details may be made without departing from the spirit and scope of the disclosure defined by claims and their equivalents.

1. A method for transmitting video data, comprising:
layering an original video into a plurality of video data streams;
embedding extended information corresponding with the original video in at least one data packet of at least one video data stream among the plurality of video data streams, the extended information comprises feature information of a preset video data stream, the feature information comprising at least one of a transmission rate of a video data stream, a proportion of a data size of the video data stream to data size of a base layer video data stream, or a proportion of the data size of the video data stream to a sum of data sizes of the remaining video data streams; and
transmitting the plurality of video data streams to corresponding channels respectively for transmitting.

2. The method of claim 1, wherein the layering the original video into the plurality of video data streams comprises:
layering the original video into a base layer video data stream and one or more enhancement layer video data streams,
the embedding the extended information in the at least one data packet of the at least one video data stream among the plurality of video data comprises:
embedding the extended information at least in at least one data packet of the base layer video data stream.

3. The method of claim 2, wherein the embedding the extended information at least in the at least one data packet of the base layer video data stream comprises:
embedding the extended information in the at least one data packet of the base layer video data stream, the extended information comprises feature information of the base layer video data stream and feature information of at least one enhancement layer video data stream.

4. The method of claim 2, wherein the embedding the extended information at least in the at least one data packet of the base layer video data stream comprises:
embedding the extended information in the at least one data packet of the base layer video data stream, the extended information comprises feature information of the base layer video data stream and feature information of an enhancement layer video data stream adjacent to the base layer video data stream; and
embedding the extended information in at least one data packet of each enhancement layer video data stream, the extended information for each enhancement layer video data stream comprises feature information of the enhancement layer video data stream itself and feature information of a video data stream adjacent to the enhancement layer video data stream.

5. (canceled)

6. The method of claim 1, wherein the extended information further comprises at least one of a first identifier for indicating that a data packet is embedded with the extended information, a number of video data streams corresponding to the feature information included in the extended information, a number of types of the feature information in the extended information and an embedding mode of the extended information.

7. A method for receiving video data, comprising:
receiving video data streams corresponding to a currently accessed multicast combination, wherein at least one data packet of at least one video data stream in the corresponding video data streams is embedded with extended information corresponding to the currently accessed multicast combination, and the extended information comprises feature information of a preset video data stream;
extracting the feature information from the extended information;
acquiring quality of experience information of a currently played video based on the video;
obtaining a multicast access strategy using a multicast prediction model, based on the extracted feature information and the quality of experience information; and
adjusting the currently accessed multicast combination based on the multicast access strategy.

8. The method of claim 7, wherein the corresponding video data streams comprise a base layer video data stream; or
the corresponding video data streams comprise the base layer video data stream and one or more enhancement layer video data streams,
wherein the extended information is embedded at least in at least one data packet of the base layer video data stream.

9. The method of claim 8, wherein the extended information is embedded in the at least one data packet of the base layer video data stream, the extended information comprises feature information of the base layer video data stream and feature information of at least one enhancement layer video data stream.

10. The method of claim 8, wherein
the extended information is embedded in the at least one data packet of the base layer video data stream, the extended information comprises feature information of the base layer video data stream and feature information of an enhancement layer video data stream adjacent to the base layer video data stream; and
the extended information is embedded in at least one data packet of each enhancement layer video data stream among the one or more enhancement layer video streams, the extended information for each enhancement layer video data stream comprises feature information of the enhancement layer video data stream itself and feature information of a video data stream adjacent to the enhancement layer video data stream.

11. The method of claim 7, wherein the feature information extracted from the extended information comprises at least one type of a transmission rate of a video data stream, a proportion of data size of the video data stream to data size of a base layer video data stream, and a ratio of the data size of the video data stream to a sum of data sizes of the remaining video data streams.

12. The method of claim 7, wherein the extended information further comprises at least one type of a first identifier for indicating that a data packet is embedded with the extended information, a number of video data streams corresponding to the feature information included in the extended information, a number of types of the feature information in the extended information and an embedding mode of the extended information.

13. The method of claim 7, wherein the quality of experience information comprises at least one of a jitter duration, an average codec bit rate and a frame rate deviation.

14. A device for transmitting video data, comprising:
at least one processor configured to:
layer an original video into a plurality of video data streams;
embed extended information corresponding to the original video in at least one data packet of at least one video data stream among the plurality of video data streams, the extended information comprises feature information of a preset video data stream, the feature information comprising at least one of a transmission rate of a video data stream, a proportion of a data size of the video data stream to data size of a base layer video data stream, or a proportion of the data size of the video data stream to a sum of data sizes of the remaining video data streams; and
transmit the plurality of video data streams to corresponding channels respectively for transmitting.

15. The device of claim 14, wherein the at least one processor is configured to:
layer the original video into a base layer video data stream and one or more enhancement layer video data streams, and
embed the extended information at least in at least one data packet of the base layer video data stream.

16. The device of claim 15, wherein the at least one processor is configured to embed the extended information in the at least one data packet of the base layer video data stream, the extended information comprises feature information of the base layer video data stream and feature information of at least one enhancement layer video data stream.

17. The device of claim 15, wherein the at least one processor is configured to:
embed the extended information in the at least one data packet of the base layer video data stream, the extended information comprises feature information of the base layer video data stream and feature information of an enhancement layer video data stream adjacent to the base layer video data stream; and
embed the extended information in at least one data packet of each enhancement layer video data stream, the extended information for each enhancement layer video data stream comprises feature information of the enhancement layer video data stream itself and feature information of a video data stream adjacent to the enhancement layer video data stream.

18. (canceled)

19. The device of claim 14, wherein the extended information further comprises at least one of a first identifier for indicating that the data packet is embedded with the extended information, a number of video data streams corresponding to the feature information included in the extended information, a number of types of the feature information in the extended information and an embedding mode of the extended information.

20.-30. (canceled)
